(19) United States
(12) Patent Application Publication
(10) Pub. No.: US 2024/0054424 A1
(43) Pub. Date: Feb. 15, 2024

(54) METHOD AND APPARATUS FOR DETERMINING RESPONSES TO DANGEROUS SITUATIONS BASED ON DEGREES OF DANGER

(71) Applicant: ELECTRONICS AND TELECOMMUNICATIONS RESEARCH INSTITUTE, Daejeon (KR)

(72) Inventors: Hyunho PARK, Daejeon (KR); Eunjung KWON, Sejong-si (KR); Sungwon BYON, Daejeon (KR); Junho YOON, Daejeon (KR); Ingyue HAN, Daejeon (KR); Dong Man JANG, Sejong-si (KR); Eui-Suk JUNG, Daejeon (KR)

(73) Assignee: ELECTRONICS AND TELECOMMUNICATIONS RESEARCH INSTITUTE, Daejeon (KR)

(21) Appl. No.: 18/345,495

(22) Filed: Jun. 30, 2023

(30) Foreign Application Priority Data
Aug. 11, 2022 (KR) 10-2022-0100480

(51) Int. Cl. G06Q 10/0635; G06Q 50/26

(52) U.S. Cl. CPC G06Q 10/0635; G06Q 50/265

(57) ABSTRACT

Disclosed herein are a method and apparatus for determining responses to dangerous situations based on the degrees of danger. The method includes generating predicted danger information of a crime scene and predicting current danger information of the crime scene based on pieces of report content information and pieces of field police report content information, calculating information about a range of dispatched police force based on pieces of dispatched police report content information, calculating information about a current field police force status and a range of the field police force based on the field police report content information, and determining a response to the crime scene based on supportable resource information for the crime scene, the predicted danger information, the current danger information, the dispatched police force range information, and the information about the current field police force status and the range of the field police force.

### CROSS REFERENCE TO RELATED APPLICATION

This application claims the benefit of Korean Patent Application No. 10-2022-0100480, filed Aug. 11, 2022, which is hereby incorporated by reference in its entirety into this application.

### BACKGROUND OF THE INVENTION

### 1. Technical Field

The present disclosure relates generally to technology for predicting the degree of danger of a crime scene in which a crime occurs, and determining a response to the crime scene based on the predicted danger degree.

### 2. Description of the Related Art

Recent rapid social and economic growth causes positive results, but incurs the anxiety of encountering crime damages due to a gradually increased number of crimes, together with the positive results. Due to problems such as economic inequalities and bipolarization, the cases where an act of violence occurs without provocations have increased even in places regarded as being relatively safe in the past.

Especially, crimes against women and children have increased and have become a social problem. Persons who feel a threat to their own safety currently have requested personal protection from police officers in a police station or from a private security or guard company, but an institution taking charge of personal protection, such as the police station or the guard company, undergoes a serious shortage of personnel or equipment compared to the need therefor, thus making it difficult to efficiently manage all persons who request personal protection.

The crime scene response capabilities of a field police officer (i.e., an on-scene police officer) who has arrived at a crime scene and a dispatched police officer who is being dispatched to the crime scene in the event of the crime may vary depending on the capabilities of individual police officers, and the scale of damage in the crime scene may also vary depending on the crime scene response capabilities of the field police officer and the dispatched police officer.

### SUMMARY OF THE INVENTION

Accordingly, the present disclosure has been made keeping in mind the above problems occurring in the prior art, and an object of the present disclosure is to predict the degree of danger based on information acquired from a scene in which a crime has occurred.

Another object of the present disclosure is to provide a response to a crime based on the predicted degree of danger.

In accordance with an aspect of the present disclosure to accomplish the above objects, there is provided a method for determining responses to dangerous situations based on degrees of danger, including generating predicted danger information of a crime scene and predicting current danger information of the crime scene based on pieces of report content information and pieces of field police report content information, calculating information about a range of dispatched police force based on pieces of dispatched police report content information, calculating information about a current field police force status and a range of the field police force based on the field police report content information, and determining a response to the crime scene based on supportable resource information for the crime scene, the predicted danger information, the current danger information, the dispatched police force range information, and the information about the current field police force status and the range of the field police force.

Generating the predicted danger information may include generating suspect action prediction information based on first report content information including at least one of a crime type, report contents or dispatch code, or a combination thereof, among the pieces of report content information, second report content information including at least one of personal details of a suspect, a past dangerous action taken by the suspect, or suspect movement information, or a combination thereof, among the pieces of report content information, and first field police report content information including at least one of a field police report, an action of the suspect, a criminal tool of the suspect, physical damage to a victim, personal details of the victim or a location of the victim, or a combination thereof, among the pieces of field police report content information, generating crime type-based danger prediction information based on the first report content information and third report content information including predicted danger actions for respective crimes among the pieces of report content information, generating crime scene-based danger prediction information based on the first report content information and fourth report content information including a past danger history of the crime scene, among the pieces of report content information, and generating the predicted danger information based on the first report content information, the suspect action prediction information, the crime type-based danger prediction information, and the crime scene-based danger prediction information.

The predicted danger information may include at least one of a predicted danger degree, a predicted crime type, a predicted criminal tool, or predicted damage information, or a combination thereof.

The predicted danger degree may be calculated using a predicted suspect action level score, dangerous action level scores for respective predicted crime types, dangerous action level scores for respective predicted crime scenes, and at least one of a weight for each crime type estimated from the first report content information or a weight for dispatch code, or a combination thereof.

Predicting the current danger information may include generating a suspect action production information based on first report content information including at least one of a crime type, report contents, or dispatch code, or a combination thereof, among the pieces of report content information, and first field police report content information including a field police report, an action of a suspect, a criminal tool of the suspect, physical damage to a victim, personal details of the victim or a location of the victim, or a combination thereof, among the pieces of field police report content information, and obtaining current danger information of the crime scene based on the first report content information and the suspect action production information.

The current danger information may include at least one of a current danger degree, a predicted crime type, a current criminal tool or current damage information, or a combination thereof.

The current danger degree may be calculated using at least one of an action level score of a current suspect or a weight for a crime type calculated from the first report content information, or a combination thereof.

Calculating the information about the range of the dispatched police force may include obtaining information about an equipment range of dispatched police based on first dispatched police report content information including at least one of a dispatched police report, equipment owned by each dispatched police officer or equipment contained in a patrol car, or a combination thereof, among the pieces of dispatched police report content information, and obtaining the information about the range of the dispatched police force based on the information about the equipment range of the dispatched police and second dispatched police report content information including at least one of the dispatched police report, personal details of each dispatched police officer, a location of the dispatched police officer, or a location of the patrol car, or a combination thereof, among the pieces of dispatched police report content information.

The information about the range of the dispatched police force may include at least one of a maximum score of the dispatched police force, a range of equipment owned by the dispatched police officer, or a location of each piece of equipment of the dispatched police officer, or a combination thereof.

Calculating the information about the current field police force status and the range of the field police force may include obtaining field police force information based on second field police report content information including at least one of a field police report, equipment used by each field police officer, or a field police response, or a combination thereof, among the pieces of field police report content information, obtaining a current field police force status based on the field police force information, obtaining field police equipment information based on third field police report content information including at least one of a field police report or equipment owned by the field police officer, or a combination thereof, among the pieces of field police report content information, obtaining information about the range of the field police force based on the field police equipment information and fourth field police report content information including at least one of the field police report or personal details of the field police officer, or a combination thereof, among the pieces of field police report content information, and calculating the range of the field police force based on the field police force range information.

The current field police force status may include at least one of a current field police force status score or current field police equipment usage status, or a combination thereof.

The range of the field police force may include at least one of a maximum score of the field police force or a range of equipment owned by the field police officer, or a combination thereof.

Determining the response may include determining a response to a predicted danger using at least one of the predicted danger, the range of the dispatched police force, the supportable resource information, or information about the range of the field police force, or a combination thereof, and determining a response to current danger based on the current danger and information about the current field police force status and the range of the field police force.

The response to the predicted danger may include at least one of a dispatched police force score for responding to predicted danger, a field police force score for responding to the predicted danger, an additional force score for responding to the predicted danger, a dispatched police response to the predicted danger, a field police response to the predicted danger, or an additional police response to the predicted danger, or a combination thereof.

The response to the current danger may include at least one of a field police force score for responding to the current danger or a field police response to the current danger, or a combination thereof.

The pieces of report content information may include information about report contents, dispatch code, a crime type, personal details of a suspect, a past dangerous action taken by the suspect, movement of the suspect, predicted dangerous actions for respective crimes, and a past danger history of the crime scene.

The field police report content information may include at least one of pieces of information about a field police report, personal details of each field police officer, equipment used by the field police officer, equipment owned by the field police officer, a field police response, an action of a suspect, a criminal tool of the suspect, physical damage to a victim, a location of the victim or personal details of the victim, or a combination thereof.

The dispatched police content information may include at least one of a dispatched police report, personal details of each dispatched police officer, a location of the dispatched police officer, equipment owned by the dispatched police officer, a location of a patrol car or equipment contained in the patrol car, or a combination thereof.

The supportable resource information may include at least one of information about field-supportable personnel, information about field-supportable vehicles, or information about field-supportable equipment, or a combination thereof.

In accordance with another aspect of the present disclosure to accomplish the above objects, there is provided an apparatus for determining responses to dangerous situations based on degrees of danger, including memory configured to store a control program for responding to dangerous situations, and a processor configured to execute the control program stored in the memory, wherein the processor is configured to generate predicted danger information of a crime scene and predicting current danger information of the crime scene based on pieces of report content information and pieces of field police report content information, calculate information about a range of dispatched police force based on pieces of dispatched police report content information, calculate information about a current field police force status and a range of the field police force based on the field police report content information, and determine a response to the crime scene based on supportable resource information for the crime scene, the predicted danger information, the current danger information, the dispatched police force range information, and the information about the current field police force status and the range of the field police force.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a block diagram illustrating an apparatus for determining responses to dangerous situations based on the degrees of a danger according to an embodiment of the present disclosure;

FIG. 2 is a block diagram illustrating the detailed configuration of the danger prediction unit of FIG. 1;

FIG. 3 is a diagram illustrating an action level classification table for crime suspects;

FIG. 4 is a diagram illustrating an example of weight values for crime types;

FIG. 5 is a diagram illustrating WC(t), classification criteria, and dispatch target times depending on dispatch system code levels of the 112 emergency call;

FIG. 6 is a block diagram illustrating the detailed configuration of the danger calculation unit of FIG. 1;

FIG. 7 is a diagram illustrating police force levels;

FIG. 8 is a block diagram illustrating the detailed configuration of the dispatched police force range calculation unit of FIG. 1;

FIG. 9 is a block diagram illustrating the detailed configuration of the field police force status and range calculation unit of the of FIG. 1;

FIG. 10 is a block diagram illustrating the detailed configuration of the response determination unit of FIG. 1;

FIG. 11 is a diagram illustrating schemes for forming PPD(t), PPN(t), and APN(t);

FIG. 12 is a diagram illustrating a scheme for forming NPN;

FIG. 13 is a flowchart illustrating a method for determining responses to dangerous situations based on the degrees of danger according to an embodiment of the present disclosure;

FIG. 14 is a flowchart illustrating the detailed process of generating predicting danger prediction information;

FIG. 15 is a flowchart illustrating the detailed process of calculating current danger information;

FIG. 16 is a flowchart illustrating the detailed process of obtaining information about the range of dispatched police force;

FIG. 17 is a flowchart illustrating the detailed process of obtaining the current field police force status and the range of field police force;

FIG. 18 is a flowchart illustrating the detailed process of determining responses; and

FIG. 19 is a block diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Embodiments of the present disclosure will now be described in detail with reference to the accompanying drawings Like numerals refer to like elements throughout, and overlapping descriptions will be omitted.

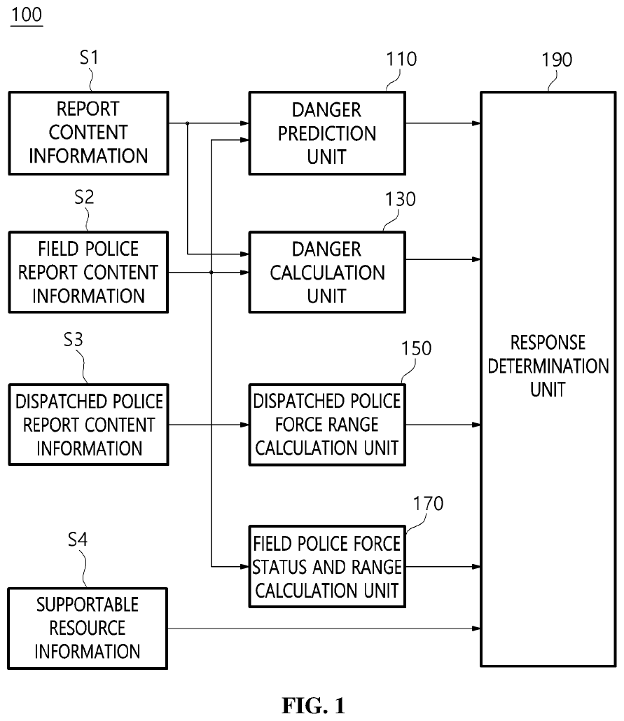

FIG. 1 is a block diagram illustrating an apparatus for determining responses to dangerous situations based on the degrees of danger according to an embodiment of the present disclosure.

Referring to FIG. 1, an apparatus 100 for determining responses to dangerous situations according to an embodiment may include a danger prediction unit 110, a danger calculation unit 130, a dispatched police force range calculation unit 150, a field (on-scene) police force status and range calculation unit 170, and a response determination unit 190.

The danger prediction unit 110 may predict danger information of a crime scene based on pieces of report content information S1 and pieces of field police report content information S2.

The pieces of report content information S1 may include information about report contents, dispatch code, a crime type, personal details of a suspect, past dangerous actions taken by the suspect, the movement of the suspect, predicted dangerous actions for respective crimes, and a past danger history of the crime scene.

The pieces of field police report content information S2 may include information about a field police report, personal information of each field police officer, equipment used by the field police officer, equipment owned by the field police officer, field police responses, the action of a suspect, the criminal tools of the suspect, physical damage to a victim, the location of the victim, and personal details of the victim.

For example, each of the danger prediction unit 110, the danger calculation unit 130, the dispatched police force range calculation unit 150, the field police force status and range calculation unit 170, and the response determination unit 190 may be implemented as a deep learning model.

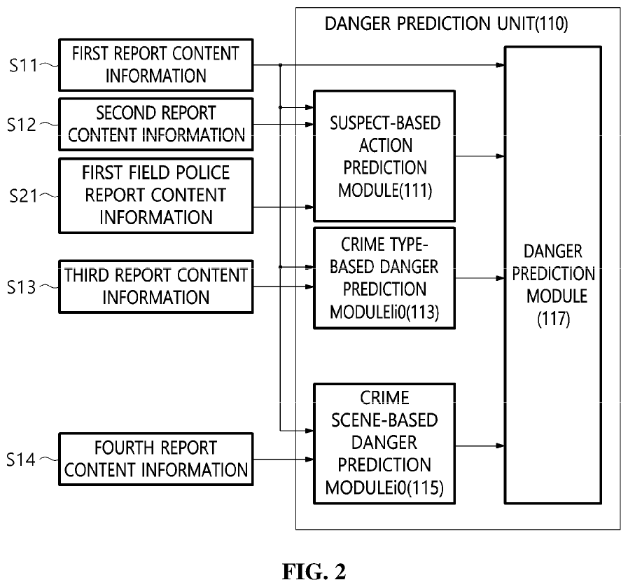

FIG. 2 is a block diagram illustrating the detailed configuration of the danger prediction unit of FIG. 1.

Referring to FIG. 2, the danger prediction unit 110 may include a suspect-based action prediction module 111, a crime type-based danger prediction module 113, a crime scene-based danger prediction module 115, and a danger prediction module 117.

The suspect-based action prediction module 111 may generate suspect action prediction information based on first report content information S11, second report content information S12, and first field police report content information S21.

The suspect-based action prediction module 111 may calculate information about the type of crime occurring in a crime scene based on the first report content information S11. The suspect-based action prediction module 111 may detect the past action taken by the suspect based on the second report content information S12. The suspect-based action prediction module 111 may detect the current action of the suspect based on the first field police report content information S21.

The suspect-based action prediction module 111 may predict the future action of the suspect based on the calculated/detected information.

The first report content information S11 may include at least one of a crime type, report contents or dispatch code, or a combination thereof, among the pieces of report content information S1. The second report content information S12 may include at least one of the personal details of the suspect, past dangerous actions taken by the suspect, or the movement information of the suspect, or a combination thereof, among the pieces of report content information S1. The first field police report content information S21 may include at least one of a field police report, the action of the suspect, the criminal tools of the suspect, physical damage to a victim, personal details of the victim or the location of the victim, or a combination thereof, among the pieces of field police report content information S2.

The suspect action prediction information may calculate predicted suspect action information (e.g., assault, escape, or threat) the suspect action level SDP(t), and a predicted suspect action level score SP(t) over time t after the current time.

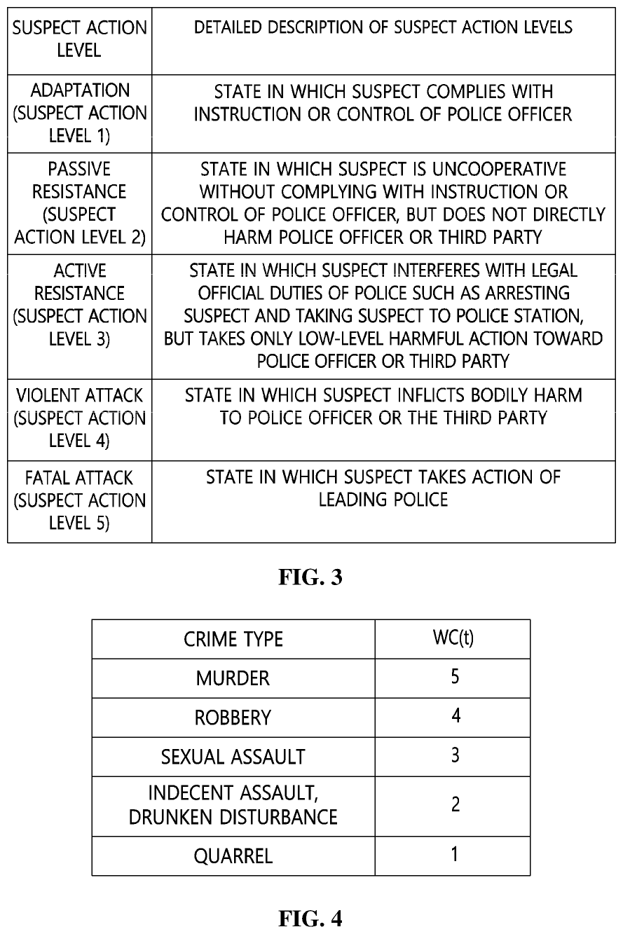

FIG. 3 is a diagram illustrating an action level classification table for crime suspects.

As illustrated in FIG. 3, suspect action levels may be categorized into suspect action level 1, suspect action level 2, suspect action level 3, suspect action level 4, and suspect action level 5.

Suspect action level 1 (adaptation or compliance) may denote the state in which the suspect complies with the instruction or control of a police officer. Suspect action level 2 (passive resistance) may denote the state in which the suspect is uncooperative without complying with the instruction or control of the police officer, but does not directly harm the police officer or a third party. Suspect action level 3 (active resistance) may denote the state in which the suspect interferes with legal official duties of the police such as arresting the suspect and taking the suspect to the police station, but takes only a low-level harmful action toward the police officer or the third party. Suspect action level 4 (violent attack) may denote the state in which the suspect inflicts bodily harm to the police officer or the third party. Suspect action level 5 (fatal attack) denotes the state in which the suspect conducts action of leading the police officer or the third party to death or causing devastating injury.

SP(t) may be calculated depending on the value of the suspect action level SDP(t). For example, when SDP(t) is level 1, SP(t) may be 0.2. When SDP(t) is level 2, SP(t) may be 0.4. When SDP(t) is level 3, SP(t) may be 0.6. When SDP(t) is level 4, SP(t) may be 0.8. When SDP(t) is level 5, SP(t) may be 1.0. A detailed value of SP(t) may be determined according to selection by the National Police Agency that is the corresponding organization.

Referring back to FIG. 2, the crime type-based danger prediction module 113 may generate crime type-based danger prediction information based on the first report content information S11 and third report content information S13. The third report content information S13 may include crime-based predicted dangerous action information, among the pieces of report content information S1.

The crime type-based danger prediction information may be generated by calculating suspect actions for respective crime types (e.g., assault, escape, or threat) over time t, predicted suspect dangerous action levels for respective crime types CDP(t), and predicted dangerous action level scores for respective crime types CP(t).

CP(t) may be calculated depending on the value of CDP(t). For example, when CDP(t) is level 1, CP(t) may be 0.2. When CDP(t) is level 2, CP(t) may be 0.4. When CDP(t) is level 3, CP(t) may be 0.6. When CDP(t) is level 4, CP(t) may be 0.8. When CDP(t) is level 5, CP(t) may be 1.0. A detailed value of CP(t) may be determined according to the selection by the National Police Agency that is the corresponding organization.

The crime scene-based danger prediction module 115 may generate crime scene-based danger prediction information based on the first report content information S11 and fourth report content information S14. The fourth report content information S14 may include past danger information of the crime scene, among the pieces of report content information S1.

The crime scene-based danger prediction information may be generated by calculating information about suspect actions for respective crime types over time t (e.g., assault, escape, or threat), predicted suspect dangerous action levels PDP(t) for respective crime scenes, and dangerous action level scores for respective predicted crime scenes PP(t).

PP(t) may be calculated depending on the value of PDP(t). For example, when PDP(t) is level 1, PP(t) may be 0.2. When PDP(t) is level 2, PP(t) may be 0.4. When PDP(t) is level 3, PP(t) may be 0.6. When PDP(t) is level 4, PP(t) may be 0.8. When PDP(t) is level 5, PP(t) may be 1.0. A detailed value of PP(t) may be determined according to the selection by the National Police Agency that is the corresponding organization.

The danger prediction module 117 may generate predicted danger information of the corresponding crime scene based on the first report content information S11, the suspect action prediction information, the crime type-based danger prediction information, and the crime scene-based danger prediction information.

The predicted danger information may include information about a predicted danger degree, a predicted crime type, a predicted criminal tool, and predicted damage.

The predicted danger degree may be calculated not only using the predicted suspect action level score SP(t), the dangerous action level scores for respective predicted crime types CP(t), and the dangerous action level scores for respective predicted crime scenes PP(t), but also using a weight WC(t) for each crime type estimated from the first report content information and a weight WD(t) for dispatch code. The weight WD(t) for dispatch code may be code for the existing 112 emergency call dispatch system, and report contents may be details reported by a victim or a third party through the 112 emergency call.

FIG. 4 is a diagram illustrating examples of weights corresponding to crime types.

As illustrated in FIG. 4, when the crime type is ‘murder’, WC(t) may be 5. When the crime type is ‘robbery’, WC(t) may be 4. When the crime type is ‘sexual assault’, WC(t) may be 3. When the crime type is ‘indecent assault or drunken disturbance’, WC(t) may be 2. When the crime type is a ‘quarrel’, WC(t) may be 1.

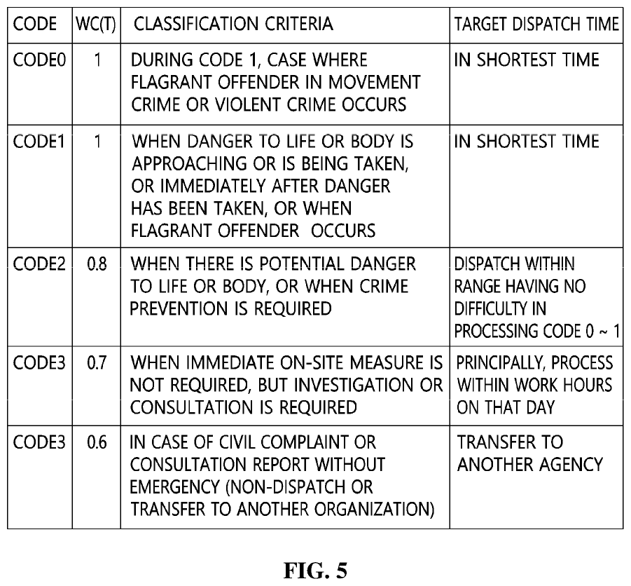

FIG. 5 is a diagram illustrating the weight WC(t), classification criteria, and dispatch target time depending on the code levels of the 112 emergency call dispatch system.

As illustrated in FIG. 5, dispatch codes may include Code 0 to Code 4. The weight WC(t) of Code 0 and Code 1 may be 1. The weight WD(t) of Code 2 may be 0.8. The weight WC (t) of Code 3 may be 0.7. The weight WC(t) of Code 4 may be 0.6.

The predicted danger degree DP(t) may be calculated using the following Equation (1). Here, Func( ) may be an arbitrary function for calculating the predicted danger degree, and may be any one of a maximum value function Max( ) a minimum value function Min( ), and an average value function Avg( ).

DP(t)=Σᵢ₌₁^{N}^{_{CP}}{WCᵢ(t)×WDᵢ(t)×Func(SPᵢ(t),CPᵢ(t),PPᵢ(t))} (1)

The predicted danger degree DP(t) may be calculated using WC(t), WD(t), SP(t), CP(t), and PP(t) for an i-th suspect among No) predicted suspects in the crime scene.

Referring back to FIG. 1, the danger calculation unit 130 may calculate the danger of the scene in which the crime is occurring, based on the report content information S1 and the field police report content information S2.

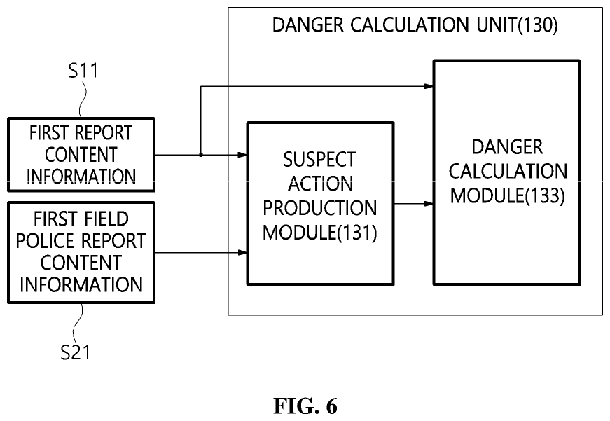

FIG. 6 is a block diagram illustrating the detailed configuration of the danger calculation unit of FIG. 1.

As illustrated in FIG. 6, the danger calculation unit 130 may include a suspect action production module 131 and a danger calculation module 133.

The suspect action production module 131 may generate suspect action production information based on first report content information S11 and first field police report content information S21, among pieces of field police report content information.

The first field police report content information S21 may include at least one of a field police report, the action of a suspect, the criminal tools of the suspect, physical damage to a victim, personal details of the victim or the location of the victim, or a combination thereof, among pieces of field police report content information S2.

The suspect action production module 131 may obtain information about the type of crime occurring in a crime scene from the first report content information S11, may obtain the current action of the suspect from the first field police report content information S21, and may generate the suspect action production information by aggregating the obtained crime type information and the current action of the suspect.

The suspect action production information may be generated by calculating a suspect action level (SDN) that is currently calculated and a current suspect action level score SN. The SDN may include suspect action level 1 to suspect action level 5.

SN may be calculated depending on the value of SDN. For example, when SDN is level 1, SD may be 0.2. When SDN is level 2, SD may be 0.4. When SDN is level 3, SD may be 0.6. When SDN is level 4, SD may be 0.8. When SDN is level 5, SD may be 1.0. A detailed value of SN may be determined according to the selection by the National Police Agency that is the corresponding organization.

The danger calculation module 133 may calculate the current danger information of the crime scene based on the suspect action production information and the first report content information S11. The current danger information may include at least one of a current danger degree, a current crime type, a current criminal tool, or current damage information, or a combination thereof.

The current danger degree may be calculated using the current suspect action level score SN and the weight W/N of the crime type estimated from the first report content information S11. Here, W/N may be identical to that of FIG. 4. That is, W/N may be the value of the weight WC(t).

The current danger degree DN may be calculated using the following Equation (2):

DN=Σᵢ₌₁^{N}^{_{CN}}{WNᵢ×SNᵢ} (2)

That is, the current danger degree DN may be calculated using WNᵢ and SNᵢ which are WN and SN of an i-th suspect among N_{CN} suspects in the crime scene.

Referring back to FIG. 1, the dispatched police force range calculation unit 150 may obtain information about the range of dispatched police force based on dispatched police report content information S3.

The dispatched police report content information S3 may include at least one of a dispatched police report, personal details of each dispatched police officer, the location of the dispatched police officer, equipment owned by the dispatched police officer, the location of a patrol car or equipment contained in the patrol car, or a combination thereof.

In order to respond to the danger of a crime, force such as handcuffs, a police baton, or a shield of a dispatched police officer or a field police officer is required. The police force according to the present disclosure may be determined based on the force described in Established Regulation No. 550 of the National Policy Agency.

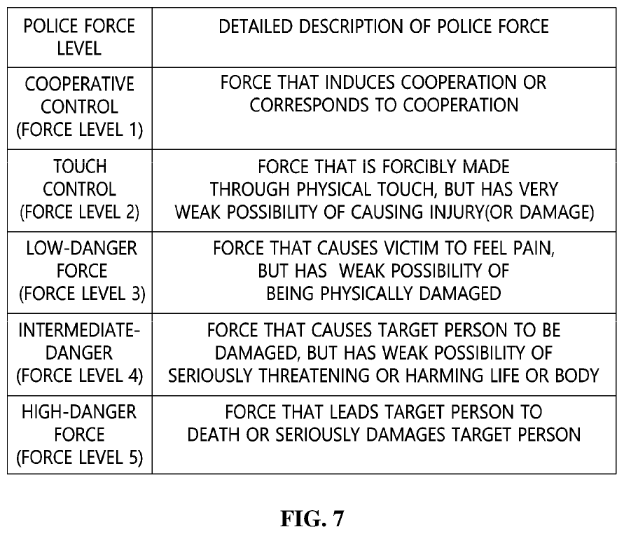

FIG. 7 is a diagram illustrating police force levels.

As shown in FIG. 7, the police force levels may include cooperative control (force level 1), touch control (force level 2), low-danger force (force level 3), an intermediate-danger force (force level 4), and high-danger force (force level 5).

The dispatched police force range calculation unit 150 may calculate a force range within which a police officer who is dispatched to the crime scene is capable of responding to the danger of a crime, and may generate the range information of dispatched police force.

The dispatched police force range calculation unit 150 may calculate the range of the force that can be used by each dispatched police officer, based on equipment owned by the dispatched police officer and the proficiency of the dispatched police officer in the force (e.g., ability to use a Taser gun or inability to use a gun).

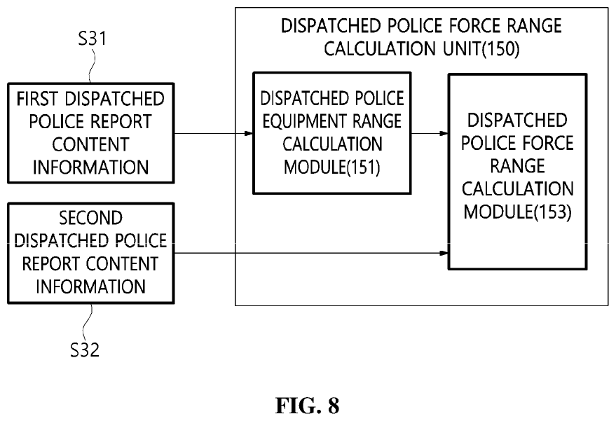

FIG. 8 is a block diagram illustrating the detailed configuration of the dispatched police force range calculation unit.

Referring to FIG. 8, the dispatched police force range calculation unit 150 may include a dispatched police equipment range calculation module 151 and a dispatched police force range calculation module 153.

The dispatched police equipment range calculation module 151 may check equipment owned by the dispatched police officer, and the dispatched police force range calculation module 153 may calculate the proficiency of the dispatched police officer in the owned equipment, thus obtaining the range of the dispatched police force.

More particularly, the dispatched police equipment range calculation module 151 may obtain information about the range of the equipment of each dispatched police officer based on first dispatched police report content information S31. The first dispatched police report content information S31 may include at least one of the report of a dispatched police report, equipment owned by each dispatched police officer, or equipment contained in a patrol car, or a combination thereof, among pieces of dispatched police report content information.

The information about the range of equipment of the dispatched police officer may include information about owned equipment (e.g., a police baton or a Taser gun) and information about the location of the owned equipment (e.g., dispatched police officer A owns a police baton and patrol car B may be equipped with a Taser gun).

The dispatched police force range calculation module 153 may calculate information about the range of the dispatched police force based on information about the range of equipment of the dispatched police officer and second dispatched police report content information S32. Here, the second dispatched police report content information S32 may include at least one of a dispatched police report, personal details of each dispatched police officer, the location of the dispatched police officer or the location of a patrol car, or a combination thereof, among pieces of dispatched police report content information.

The dispatched police force range calculation module 153 may calculate proficiency in the equipment owned by the dispatched police officer or contained in the patrol car, based on the information about the range of equipment of the dispatched police officer and second dispatched police report content information S32, and may obtain information about the range of dispatched police force using the calculated proficiency.

The information about the range of the dispatched police force may include the maximum score PDM of the dispatched police force, the range of the equipment owned by the dispatched police officer and information about the location of each piece of equipment owned by the dispatched police officer.

PDM may be calculated using the following Equation (3). PDM may be represented by the sum of the maximum force scores of respective dispatched police officers.

PDM=Σᵢ₌₁^{N}^{_{PD}}(WPDMᵢ×pdmᵢ) (3)

Here, N_{PD} denotes the number of dispatched police officers, pdmᵢ denotes the maximum force score of an i-th dispatched police officer, and WPDMᵢ denotes the weight of proficiency of the i-th dispatched police officer in the maximum force. Here, pdmᵢ may be proportional to the force level of FIG. 4 that can be used by the dispatched police officer.

For example, the value of PDM may be 5 when the force level that can be used by the corresponding dispatched police officer is level 5, may be 4 when the force level that can be used by the corresponding dispatched police officer is level 4, may be 3 when the force level that can be used by the corresponding dispatched police officer is level 3, may be 2 when the force level that can be used by the corresponding dispatched police officer is level 2, and may be 1 when the force level that can be used by the corresponding dispatched police officer is level 1.

The value of pdmᵢ may be compared with the DP(t) of Equation (1) by the response determination unit, and may be a criterion for determining whether it is possible to respond to the scene using only dispatched police personnel and equipment owned thereby. WPDMᵢ may have, for example, a value ranging from 0.1 to 1 depending on the proficiency of the corresponding dispatched police officer in the maximum force. If the value of PDM of the dispatched police officer is less than DP(t), the response determination unit may determine to add dispatched police personnel or add support equipment for the dispatched police.

Referring back to FIG. 1, the field police force status and range calculation unit 170 may calculate the current status of field police force and information about the range of the force based on field police report content information S2.

The field police force status and range calculation unit 170 may calculate the current status of force used by each field police officer who responds to the danger of a crime scene in the crime scene and the range of the force that can be used by the field police officer, thus obtaining information about the current status and range of the final field police force.

FIG. 9 is a block diagram illustrating the detailed configuration of the field police force status and range calculation unit of FIG. 1.

Referring to FIG. 9, the field police force status and range calculation unit 170 may include a field police force calculation module 171, a field police equipment calculation module 173, and a field police force range calculation module 175.

The field police force calculation module 171 may calculate information about current field police force status based on second field police report content information S22. The second field police report content information S22 may include at least one of a field police report, equipment used by each field police officer or a field police response, or a combination thereof, among piece of field police report content information S2.

The information about the current field police force status may include information about a current field police force status score PN and current field police equipment usage status. PN may be calculated using the following Equation (4):

PN=Σᵢ₌₁^{N}^{_{PN}}(WPNᵢ×pnᵢ) (4)

The value of PN may be represented by the sum of force scores of individual field police officers. NPN may be the number of field police officers, pnᵢ may be the current force status score of an i-th field police officer, and WPNᵢ may be a proficiency weight for the current force status of the i-th field police officer.

pnᵢ may be proportional to the force level of FIG. 4 that can be used by the field police officer, and the value of pnᵢ may be 5 when the force level that can be used by the corresponding field police officer is 5. The value of pnᵢ may be 4 when the force level that can be used by the corresponding field police officer is 4. The value of pnᵢ may be 3 when the force level that can be used by the corresponding field police officer is 3. The value of pnᵢ may be 2 when the force level that can be used by the corresponding field police officer is 2. The value of pnᵢ may be 1 when the force level that can be used by the corresponding field police officer is 1.

WPNᵢ may have a value ranging from 0.1 to 1 depending on the proficiency of the field police officer in the current force. The value of PN may be a criterion for determining, by the response determination unit, whether a response to a crime scene is satisfactorily conducted using only field police personnel and equipment owned thereby, compared to the value of DN in Equation (1). When the value of PN of the field police officer is less than the value of DN, the response determination unit may create additional response information for the field police officer.

The field police equipment calculation module 173 may obtain information about equipment owned by the field police officer (i.e., field police equipment information) based on third field police report content information S23. The third field police report content information S23 may include information about at least one of a field police report or equipment owned by each field police officer, or a combination thereof, among pieces of field police report content information. Here, the field police equipment information may include all types of equipment that can be used by each police officer, e.g., a police baton, a Taser gun, a handgun, etc.

The field police force range calculation module 175 may calculate information about the range of field police force based on the field police equipment information and fourth field police report content information S24. The fourth field police report content information S24 may include at least one of a field police report or personal details of each field police officer, or a combination thereof, among pieces of field police report content information.

The field police force range information may include a maximum score PNM for the field police force and information about the range of equipment owned by the corresponding field police officer.

PNM may be calculated using the following Equation (5). PNM may include the sum of the maximum force scores of respective field police officers.

PNM=Σᵢ₌₁^{N}^{_{PN}}(WPNMᵢ×pnmᵢ) (5)

NPN is the number of field police officers, pnmᵢ is the maximum force score of an i-th field police officer, and WPNMᵢ is a proficiency weight for the maximum force of the i-th field police officer. pnmᵢ may be proportional to the force level of FIG. 4 that can be used by the field police officer. For example, the value of PNM may be 5 when the force level that can be used by the corresponding field police officer is 5. The value of PNM may be 4 when the force level that can be used by the corresponding field police officer is 4. The value of PNM may be 3 when the force level that can be used by the corresponding field police officer is 3. The value of PNM may be 2 when the force level that can be used by the corresponding field police officer is 2. The value of PNM may be 1 when the force level that can be used by the corresponding field police officer is 1.

The value of pnmᵢ may be a criterion for determining, by the response determination unit, whether a response to a crime scene is capable of being satisfactorily conducted using only field police personnel and equipment owned thereby, compared to the value of DN(t) in Equation (2). WPNMᵢ may have a value ranging from 0.1 to 1 depending on the proficiency of the field police officer in the maximum police force. When the PNM value of the field police officer is less than DN(t), the response determination unit may determine to add field police personnel or add support equipment for the field police.

Referring back to FIG. 1, the response determination unit 190 may determine a response to the crime scene based on information about available resources to be supported in a crime scene (i.e., supportable resource information S4), the predicted danger information, the current danger information, the dispatched police force range information, and the current field police force status and force range information.

The supportable resource information S4 may include at least one of information about field-supportable personnel, information about field-supportable vehicles, or information about field-supportable equipment, or a combination thereof.

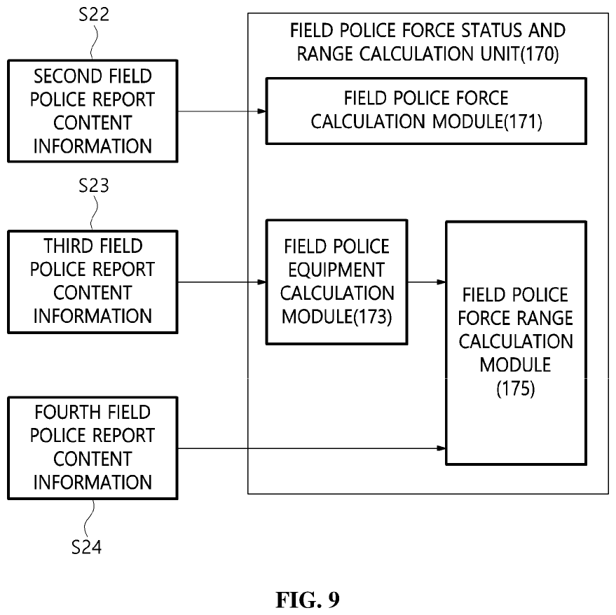

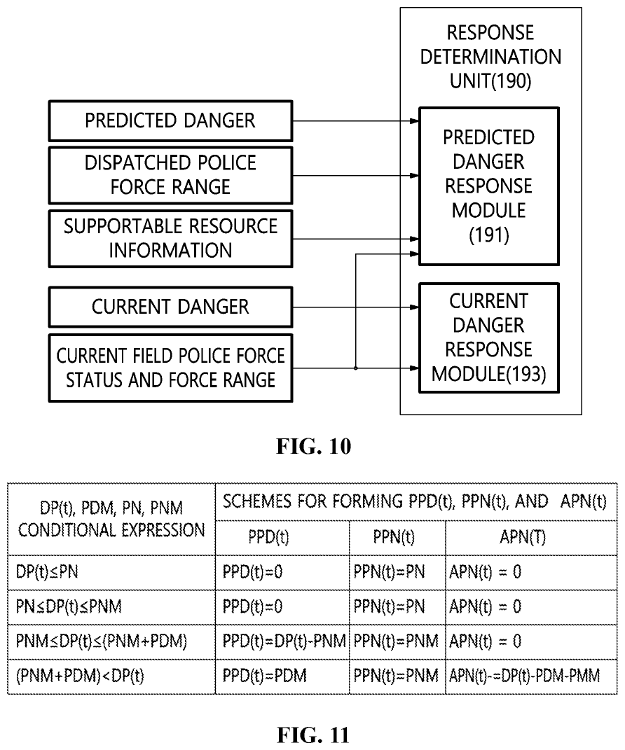

FIG. 10 is a block diagram illustrating the detailed configuration of the response determination unit of FIG. 1.

Referring to FIG. 10, the response determination unit 190 may include a predicted danger response module 191 and a current danger response module 193.

The predicted danger response module 191 may determine a predicted danger response using at least one of predicted danger, a dispatched police force range, supportable resource information or a field police force range, or a combination thereof.

The predicted danger response may include at least one of a dispatched police force score for responding to predicted danger, a field police force score for responding to predicted danger, an additional force score for responding to predicted danger, a dispatched police response to predicted danger, a field police response to predicted danger, or an additional police response to predicted danger, or a combination thereof.

The predicted danger response may be configured to obtain a predicted danger degree DP(t) after time t has elapsed from the predicted danger, by generating the maximum score PDM for the dispatched police force range, the current field police force status score PN, and the field police force score, thus generating information allowing the dispatched police and the field police to respond to the predicted danger.

FIG. 11 is a diagram illustrating schemes for forming PPD(t), PPN(t), and APN(t).

As illustrated in FIG. 11, dispatched/field/added police force and response information may be generated depending on PPD(t), PPN(t), and APN(t). When the value of APN(t) is greater than 0, the predicted danger response module may create an additional police response to the predicted danger within a range available in field-supportable resource information.

Referring to FIG. 10, the current danger response module 193 may determine the current danger response based on the current danger and the current field police force status and force range information.

The current danger response may include at least one of a field police force score for responding to the current danger or a field police response to the current danger, or a combination thereof.

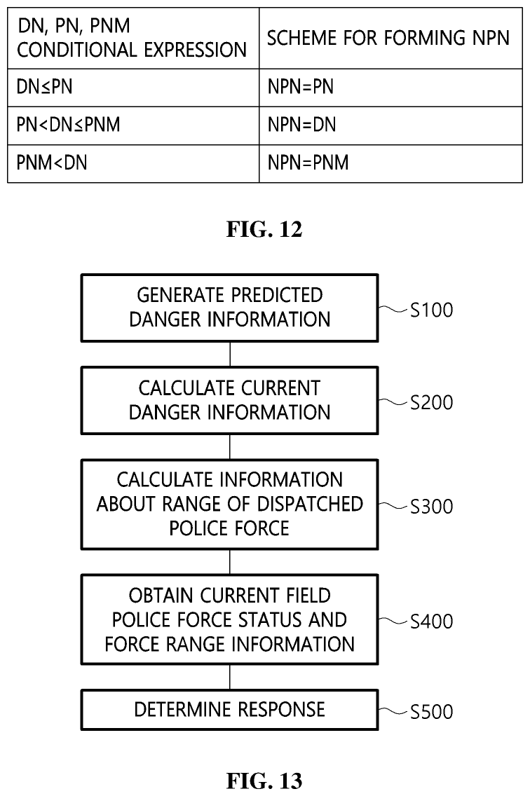

FIG. 12 is a diagram illustrating a scheme for forming NPN.

As illustrated in FIG. 12, a field police force score NPN for responding to current danger may be generated using a current danger degree DN in the current danger information, a current field police force status score PN in the current field police force status information, and a maximum score PNM for field police force in the field police force range information.

The current danger response module 193 may generate field police response information to the current danger based on NPN. On the other hand, when the value of PNM is less than DN, it may be better to avoid the danger of the crime suspect while maintaining the field police force score NPN for responding to the current danger.

FIG. 13 is a flowchart illustrating a method for determining responses to dangerous situations based on the degrees of danger according to an embodiment of the present disclosure.

Referring to FIG. 13, the method for determining responses to dangerous situations according to the embodiment may include step S100 of generating predicted danger information, step S200 of calculating current danger information, step S300 of calculating information about the range of dispatched police force, step S400 of obtaining information about the current field police force status and the range of the field police force, and step S500 of determining a response. Here, the method for determining responses to dangerous situations may be performed by an apparatus for determining responses to dangerous situations.

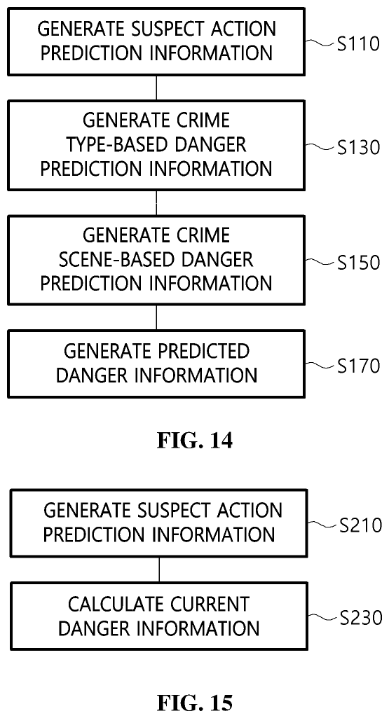

FIG. 14 is a flowchart illustrating the detailed process of generating danger prediction information.

As illustrated in FIG. 14, the apparatus may generate suspect action prediction information based on first report content information including at least one of a crime type, report contents, or dispatch code, or a combination thereof, among pieces of report content information, second report content information including at least one of personal details of a suspect, the past dangerous action taken by the suspect, or suspect movement information, or a combination thereof, among the pieces of report content information, and first field police report content information including at least one of a field police report, the action of a suspect, the criminal tool of the suspect, physical damage to a victim, personal details of the victim or the location of the victim, or a combination thereof at step S110.

The apparatus may generate crime type-based danger prediction information based on the first report content information and third report content information including a crime-based predicted dangerous action, among pieces of report content information at step S130.

The apparatus may generate crime scene-based danger prediction information based on the first report content information and fourth report content information including past danger information of a crime scene, among the pieces of report content information at step S150.

The apparatus may generate predicted danger information based on the first report content information, the suspect action prediction information, the crime type-based danger prediction information, and the crime scene-based danger prediction information at step S170.

FIG. 15 is a flowchart illustrating the detailed process of calculating current danger information.

As illustrated in FIG. 15, the apparatus may generate a suspect action production information based on first report content information including at least one of a crime type, report contents, or dispatch code, or a combination thereof, among pieces of report content information, and first field police report content information including a field police report, the action of a suspect, the criminal tools of the suspect, physical damage to a victim, the personal details of the victim or the location of the victim, or a combination thereof, among pieces of field police report content information, at step S210.

The apparatus may calculate the current danger information of the crime scene based on the first report content information and the suspect action production information at step S230.

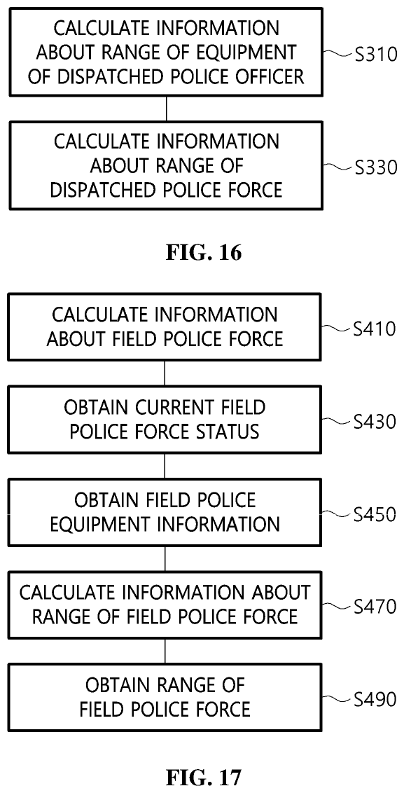

FIG. 16 is a flowchart illustrating the detailed process of calculating information about the range of dispatched police force.

As illustrated in FIG. 16, the apparatus may calculate information about the range of equipment of each dispatched police officer based on first dispatched police report content information including at least one of a dispatched police report, equipment owned by the dispatched police officer, or equipment contained in a patrol car, or a combination thereof, among pieces of information about dispatched police report contents at step S310.

The apparatus may calculate information about the range of dispatched police force based on the information about the range of equipment of each dispatched police officer and second dispatched police report content information including at least one of a dispatched police report, personal details of each dispatched police officer, the location of the dispatched police officer or the location of the patrol car, or a combination thereof, among the pieces of the dispatched police report content information, at step S330.

FIG. 17 is a flowchart illustrating the detailed process of calculating the current field police force status and the range of the field police force.

As illustrated in FIG. 17, the apparatus may calculate information about field police force based on second field police report content information including at least one of a field police report, equipment used by each field police officer, or a field police response, or a combination thereof, among pieces of field police report content information at step S410.

The apparatus may obtain the current field police force status based on the field police force information at step S430.

The apparatus may obtain field police equipment information based on third field police report content information including at least one of a field police report or field police equipment or a combination thereof, among the pieces of field police report content information, at step S450.

The apparatus may calculate information about the range of field police force based on the field police equipment information and fourth field police report content information including at least one of a field police report or personal details of each field police officer, or a combination thereof, among the pieces of field police report content information at step S470.

The apparatus may obtain the range of the field police force based on the field police force range information at step S490.

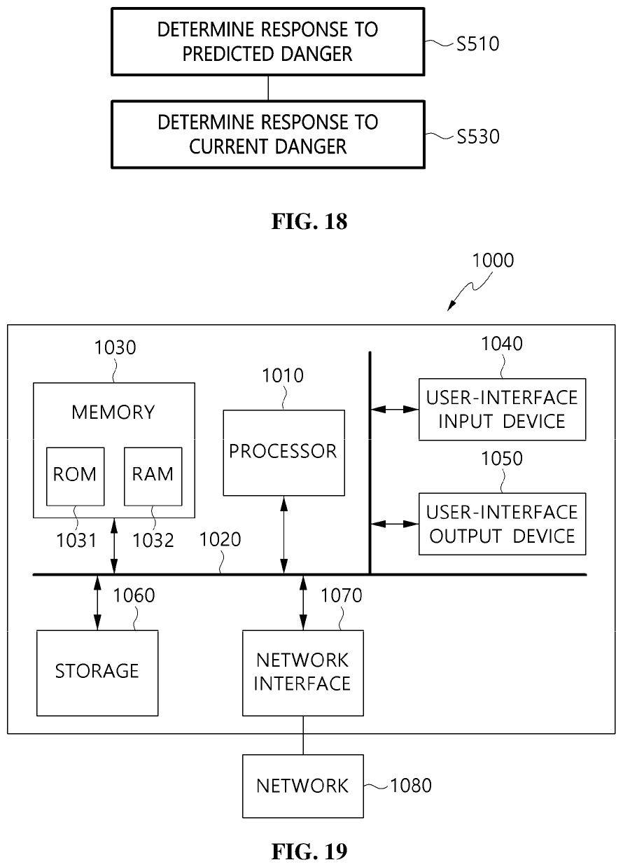

FIG. 18 is a flowchart illustrating the detailed process of determining a response.

As illustrated in FIG. 18, the apparatus may determine a response to the predicted danger using at least one of predicted danger, the range of dispatched police force, the supportable resource information, or the field police force range information, or a combination thereof at step S510.

The apparatus may determine a response to the current danger based on the current danger, the current field police force status information, and the field police force range information at step S530.

The apparatus for determining responses to dangerous situations according to the embodiment may be implemented in a computer system such as a computer-readable storage medium.

FIG. 19 is a block diagram illustrating the configuration of a computer system.

Referring to FIG. 19, a computer system 1000 according to an embodiment may include one or more processors 1010, memory 1030, a user interface input device 1040, a user interface output device 1050, and storage 1060, which communicate with each other through a bus 1020. The computer system 1000 may further include a network interface 1070 connected to a network 1080.

Each processor 1010 may be a Central Processing Unit (CPU) or a semiconductor device for executing programs or processing instructions stored in the memory 1030 or the storage 1060. The processor 1010 may be a kind of CPU, and may control the overall operation of the apparatus for determining responses to dangerous situations.

The processor 1010 may include all types of devices capable of processing data. The term processor as herein used may refer to a data-processing device embedded in hardware having circuits physically constructed to perform a function represented in, for example, code or instructions included in the program. The data-processing device embedded in hardware may include, for example, a microprocessor, a CPU, a processor core, a multiprocessor, an application-specific integrated circuit (ASIC), a field-programmable gate array (FPGA), etc., without being limited thereto.

The memory 1030 may store various types of data for the overall operation such as a control program for performing the method for determining responses to dangerous situations according to the embodiment. In detail, the memory 1030 may store multiple applications executed by the apparatus for determining responses to dangerous situations, and data and instructions for the operation of the apparatus for determining responses to dangerous situations.

Each of the memory 1030 and the storage 1060 may be a storage medium including at least one of a volatile medium, a nonvolatile medium, a removable medium, a non-removable medium, a communication medium, an information delivery medium or a combination thereof. For example, the memory 1030 may include Read-Only Memory (ROM) 1031 or Random Access Memory (RAM) 1032.

In accordance with an embodiment, a computer-readable storage medium for storing a computer program may include instructions enabling the processor to perform a method including an operation of generating predicted danger information of a crime scene and predicting current danger information of the crime scene based on pieces of report content information and pieces of field police report content information, an operation of calculating information about a range of dispatched police force based on pieces of dispatched police report content information, an operation of calculating information about a current field police force status and a range of the field police force based on the field police report content information, and an operation of determining a response to the crime scene based on supportable resource information for the crime scene, the predicted danger information, the current danger information, the dispatched police force range information, and the information about the current field police force status and the range of the field police force.

In accordance with an embodiment, a computer program stored in a computer-readable storage medium may include instructions enabling the processor to perform a method including an operation of generating predicted danger information of a crime scene and predicting current danger information of the crime scene based on pieces of report content information and pieces of field police report content information, an operation of calculating information about a range of dispatched police force based on pieces of dispatched police report content information, an operation of calculating information about a current field police force status and a range of the field police force based on the field police report content information, and an operation of determining a response to the crime scene based on supportable resource information for the crime scene, the predicted danger information, the current danger information, the dispatched police force range information, and the information about the current field police force status and the range of the field police force.

The particular implementations shown and described herein are illustrative examples of the present disclosure and are not intended to limit the scope of the present disclosure in any way. For the sake of brevity, conventional electronics, control systems, software development, and other functional aspects of the systems may not be described in detail. Furthermore, the connecting lines or connectors shown in the various presented figures are intended to represent exemplary functional relationships and/or physical or logical couplings between the various elements. It should be noted that many alternative or additional functional relationships, physical connections, or logical connections may be present in an actual device. Moreover, no item or component may be essential to the practice of the present disclosure unless the element is specifically described as “essential” or “critical”.

The present disclosure may accurately determine the situation of a crime scene by calculating and predicting the degree of danger in the crime scene.

Further, the present disclosure may effectively provide a response for supporting the dispatched police and the field police based on the degree of danger.

Therefore, the spirit of the present disclosure should not be limitedly defined by the above-described embodiments, and it is appreciated that all ranges of the accompanying claims and equivalents thereof belong to the scope of the spirit of the present disclosure.

What is claimed is:

1. A method for determining responses to dangerous situations based on degrees of danger, comprising:
generating predicted danger information of a crime scene and predicting current danger information of the crime scene based on pieces of report content information and pieces of field police report content information;
calculating information about a range of dispatched police force based on pieces of dispatched police report content information;
calculating information about a current field police force status and a range of the field police force based on the field police report content information; and
determining a response to the crime scene based on supportable resource information for the crime scene, the predicted danger information, the current danger information, the dispatched police force range information, and the information about the current field police force status and the range of the field police force.

2. The method of claim 1, wherein generating the predicted danger information comprises:
generating suspect action prediction information based on first report content information including at least one of a crime type, report contents or dispatch code, or a combination thereof, among the pieces of report content information, second report content information including at least one of personal details of a suspect, a past dangerous action taken by the suspect, or suspect movement information, or a combination thereof, among the pieces of report content information, and first field police report content information including at least one of a field police report, an action of the suspect, a criminal tool of the suspect, physical damage to a victim, personal details of the victim or a location of the victim, or a combination thereof, among the pieces of field police report content information;
generating crime type-based danger prediction information based on the first report content information and third report content information including predicted danger actions for respective crimes among the pieces of report content information;
generating crime scene-based danger prediction information based on the first report content information and fourth report content information including a past danger history of the crime scene, among the pieces of report content information; and
generating the predicted danger information based on the first report content information, the suspect action prediction information, the crime type-based danger prediction information, and the crime scene-based danger prediction information.

3. The method of claim 2, wherein the predicted danger information includes at least one of a predicted danger degree, a predicted crime type, a predicted criminal tool, or predicted damage information, or a combination thereof.

4. The method of claim 3, wherein the predicted danger degree is calculated using a predicted suspect action level score, dangerous action level scores for respective predicted crime types, dangerous action level scores for respective predicted crime scenes, and at least one of a weight for each crime type estimated from the first report content information or a weight for dispatch code, or a combination thereof.

5. The method of claim 1, wherein predicting the current danger information comprises:
generating a suspect action production information based on first report content information including at least one of a crime type, report contents, or dispatch code, or a combination thereof, among the pieces of report content information, and first field police report content information including a field police report, an action of a suspect, a criminal tool of the suspect, physical damage to a victim, personal details of the victim or a location of the victim, or a combination thereof, among the pieces of field police report content information; and
obtaining current danger information of the crime scene based on the first report content information and the suspect action production information.

6. The method of claim 5, wherein the current danger information includes at least one of a current danger degree, a predicted crime type, a current criminal tool or current damage information, or a combination thereof.

7. The method of claim 6, wherein the current danger degree is calculated using at least one of an action level score of a current suspect or a weight for a crime type calculated from the first report content information, or a combination thereof.

8. The method of claim 1, wherein calculating the information about the range of the dispatched police force comprises:
obtaining information about an equipment range of dispatched police based on first dispatched police report content information including at least one of a dispatched police report, equipment owned by each dispatched police officer or equipment contained in a patrol car, or a combination thereof, among the pieces of dispatched police report content information; and
obtaining the information about the range of the dispatched police force based on the information about the equipment range of the dispatched police and second dispatched police report content information including at least one of the dispatched police report, personal details of each dispatched police officer, a location of the dispatched police officer, or a location of the patrol car, or a combination thereof, among the pieces of dispatched police report content information.

9. The method of claim 8, wherein the information about the range of the dispatched police force includes at least one of a maximum score of the dispatched police force, a range of equipment owned by the dispatched police officer, or a location of each piece of equipment of the dispatched police officer, or a combination thereof.

10. The method of claim 1, wherein calculating the information about the current field police force status and the range of the field police force comprises:
obtaining field police force information based on second field police report content information including at least one of a field police report, equipment used by each field police officer, or a field police response, or a combination thereof, among the pieces of field police report content information;
obtaining a current field police force status based on the field police force information;
obtaining field police equipment information based on third field police report content information including at least one of a field police report or equipment owned by the field police officer, or a combination thereof, among the pieces of field police report content information;
obtaining information about the range of the field police force based on the field police equipment information and fourth field police report content information including at least one of the field police report or personal details of the field police officer, or a combination thereof, among the pieces of field police report content information; and
calculating the range of the field police force based on the field police force range information.

11. The method of claim 10, wherein the current field police force status includes at least one of a current field police force status score or current field police equipment usage status, or a combination thereof.

12. The method of claim 10, wherein the range of the field police force includes at least one of a maximum score of the field police force or a range of equipment owned by the field police officer, or a combination thereof.

13. The method of claim 1, wherein determining the response comprises:
determining a response to a predicted danger using at least one of the predicted danger, the range of the dispatched police force, the supportable resource information, or information about the range of the field police force, or a combination thereof; and
determining a response to current danger based on the current danger and information about the current field police force status and the range of the field police force.

14. The method of claim 13, wherein the response to the predicted danger includes at least one of a dispatched police force score for responding to predicted danger, a field police force score for responding to the predicted danger, an additional force score for responding to the predicted danger, a dispatched police response to the predicted danger, a field police response to the predicted danger, or an additional police response to the predicted danger, or a combination thereof.

15. The method of claim 13, wherein the response to the current danger includes at least one of a field police force score for responding to the current danger or a field police response to the current danger, or a combination thereof.

16. The method of claim 1, wherein the pieces of report content information include information about report contents, dispatch code, a crime type, personal details of a suspect, a past dangerous action taken by the suspect, movement of the suspect, predicted dangerous actions for respective crimes, and a past danger history of the crime scene.

17. The method of claim 1, wherein the field police report content information includes at least one of pieces of information about a field police report, personal details of each field police officer, equipment used by the field police officer, equipment owned by the field police officer, a field police response, an action of a suspect, a criminal tool of the suspect, physical damage to a victim, a location of the victim or personal details of the victim, or a combination thereof.

18. The method of claim 1, wherein the dispatched police content information includes at least one of a dispatched police report, personal details of each dispatched police officer, a location of the dispatched police officer, equipment owned by the dispatched police officer, a location of a patrol car or equipment contained in the patrol car, or a combination thereof.

19. The method of claim 1, wherein the supportable resource information includes at least one of information about field-supportable personnel, information about field-supportable vehicles, or information about field-supportable equipment, or a combination thereof.

20. An apparatus for determining responses to dangerous situations based on degrees of danger, comprising:
a memory configured to store a control program for responding to dangerous situations; and
a processor configured to execute the control program stored in the memory,
wherein the processor is configured to generate predicted danger information of a crime scene and predicting current danger information of the crime scene based on pieces of report content information and pieces of field police report content information, calculate information about a range of dispatched police force based on pieces of dispatched police report content information, calculate information about a current field police force status and a range of the field police force based on the field police report content information, and determine a response to the crime scene based on supportable resource information for the crime scene, the predicted danger information, the current danger information, the dispatched police force range information, and the information about the current field police force status and the range of the field police force.
